(19) United States
(12) Patent Application Publication
(10) Pub. No.: US 2017/0088372 A1
(43) Pub. Date: Mar. 30, 2017

(54) LOADING RAMP

(71) Applicant: WINSTON PRODUCTS LLC, CLEVELAND, OH (US)

(72) Inventors: Winston Breeden, III, Chagrin Falls, OH (US); Ryan William Chepla, Shaker Heights, OH (US); Robert Johnson, Montville, OH (US); Colleen Renee Kurniawan, Cleveland, OH (US); David Drabousky, Twinsburg, OH (US)

(21) Appl. No.: 14/867,075

(22) Filed: Sep. 28, 2015

(51) Int. Cl. B65G 69/30; B60P 1/43

(52) U.S. Cl. CPC B65G 69/30; B60P 1/43

(57) ABSTRACT

A loading ramp is supported between a first surface and a second surface. The loading ramp includes a first ramp portion supported on the first surface. The first ramp portion includes a first rail portion extending between a first end and an opposing second end. The first rail portion extends along a first non-linear axis. A first tread portion is fixedly attached to the first rail portion and supports a weight when the first tread portion is attached to the first rail portion. The loading ramp includes a second ramp portion attached to the first ramp portion and supported on the second surface. The second ramp portion includes a second rail portion extending between a third end, which is attached to the first rail portion, and an opposing fourth end. A second tread portion is fixedly attached to the second rail portion and supports the weight.

### CROSS REFERENCE TO RELATED APPLICATIONS

This application claims the benefit of U.S. Non-Provisional application Ser. No. 14/327,999, filed on Jul. 10, 2014, the entire disclosure of which is hereby incorporated herein by reference. This application also claims the benefit of U.S. Provisional Application No. 62/056,491, filed on Sep. 27, 2014, the entire disclosure of which is hereby incorporated herein by reference.

### TECHNICAL FIELD

The instant application is generally directed towards a loading ramp and, in particular, to a loading ramp that can support a weight and extend between two surfaces.

### BACKGROUND

A loading ramp can be used to support one or more objects. For example, a loading ramp can support a vehicle, snowmobile, motorcycle, etc. The loading ramp can be positioned to extend between a first surface and a second surface. As such, the vehicle can be moved from the first surface to the second surface by moving across/over the loading ramp. Loading ramps can be relatively long in length and may be cumbersome when stored/stowed. Furthermore, loading ramps are sometimes needed to support a relatively heavy weight, such as the heavy weights associated with vehicles. As such, it would be beneficial to provide for a loading ramp that is relatively easily stored and/or stowed while being able to support relatively heavy weights thereupon.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

In an example, a loading ramp is configured to be supported between a first surface and a second surface. The loading ramp includes a first ramp portion configured to be supported on the first surface. The first ramp portion includes a first rail portion extending between a first end, which is supported on the first surface, and an opposing second end, the first rail portion extending along a first non-linear axis. The first ramp portion includes at least one first tread portion fixedly attached to the first rail portion. The at least one first tread portion is configured to support a weight when the at least one first tread portion is attached to the first rail portion. The loading ramp includes a second ramp portion attached to the first ramp portion and configured to be supported on the second surface. The second ramp portion includes a second rail portion extending between a third end, which is attached to the second end of the first rail portion, and an opposing fourth end, which is supported on the second surface. The second rail portion extends along a second non-linear axis. The loading ramp includes at least one second tread portion fixedly attached to the second rail portion. The at least one second tread portion is configured to support the weight when the at least one second tread portion is attached to the second rail portion.

In another example, a loading ramp is configured to be supported between a first surface and a second surface. The loading ramp includes a first ramp portion configured to be supported on the first surface. The first ramp portion includes a first rail portion extending between a first end, which is supported on the first surface, and an opposing second end. The first rail portion extends along a first non-linear axis. The first ramp portion includes at least one first tread portion attached to the first rail portion. The at least one first tread portion is configured to support a weight when the at least one first tread portion is attached to the first rail portion. The loading ramp includes a second ramp portion attached to the first ramp portion. The second ramp portion includes a second rail portion extending between a third end, which is attached to the second end of the first rail portion, and an opposing fourth end. The second rail portion extends along a second non-linear axis. The second ramp portion includes at least one second tread portion attached to the second rail portion. The at least one second tread portion is configured to support the weight when the at least one second tread portion is attached to the second rail portion. The loading ramp includes a third ramp portion attached to the second ramp portion and configured to be supported on the second surface. The third ramp portion includes a third rail portion extending between a fifth end, which is attached to the fourth end of the second rail portion, and an opposing sixth end, which is supported on the second surface. The third ramp portion includes at least one third tread portion attached to the third rail portion. The at least one third tread portion is configured to support the weight when the at least one third tread portion is attached to the third rail portion.

In another example, a loading ramp is configured to be supported between a first surface and a second surface. The loading ramp includes a first ramp portion configured to be supported on the first surface. The first ramp portion extends a first distance. The first ramp portion includes a first rail portion extending between a first end, which is supported on the first surface, and an opposing second end. The first rail portion extends along a first non-linear axis. The first ramp portion includes at least one first tread portion fixedly attached to the first rail portion. The at least one first tread portion is configured to support a weight when the at least one first tread portion is attached to the first rail portion. The loading ramp includes a second ramp portion attached to the first ramp portion and is configured to be supported on the second surface. The second ramp portion extends a second distance that is greater than the first distance. The second ramp portion includes a second rail portion extending between a third end, which is attached to the second end of the first rail portion, and an opposing fourth end, which is supported on the second surface. The second rail portion extends along a second non-linear axis. The second ramp portion includes at least one second tread portion fixedly attached to the second rail portion. The at least one second tread portion is configured to support the weight when the at least one second tread portion is attached to the second rail portion.

The following description and annexed drawings set forth certain illustrative aspects and implementations. These are indicative of but a few of the various ways in which one or more aspects can be employed. Other aspects, advantages, and/or novel features of the disclosure will become apparent from the following detailed description when considered in conjunction with the annexed drawings.

### DESCRIPTION OF THE DRAWINGS

FIG. 1 is a side view of an example loading ramp supported between a first surface and a second surface;

FIG. 2 is a perspective view of the example loading ramp of FIG. 1 in a folded configuration;

FIG. 3 is an end view of the example loading ramp of FIG. 2 in a folded configuration as viewed from the perspective indicated by lines 3-3 of FIG. 2;

FIG. 4 is a side view of a second example loading ramp supported between a first surface and a second surface;

FIG. 5 is a perspective view of the second example loading ramp of FIG. 4 in a folded configuration;

FIG. 6 is an end view of the second example loading ramp of FIG. 5 as viewed from the perspective indicated by lines 6-6 of FIG. 5 in a folded configuration;

FIG. 7 is a side view of a third example loading ramp supported between a first surface and a second surface;

FIG. 8 is a side view of a fourth example loading ramp supported between a first surface and a second surface;

FIG. 9 is a perspective view of the example loading ramp of FIG. 8; and

FIG. 10 is a side view of a fifth example loading ramp supported between a first surface and a second surface.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It is evident, however, that the claimed subject matter can be practiced without these specific details. In other instances, structures and devices are illustrated in block diagram form in order to facilitate describing the claimed subject matter. Relative size, orientation, etc. of parts, components, etc. may differ from that which is illustrated while not falling outside of the scope of the claimed subject matter.

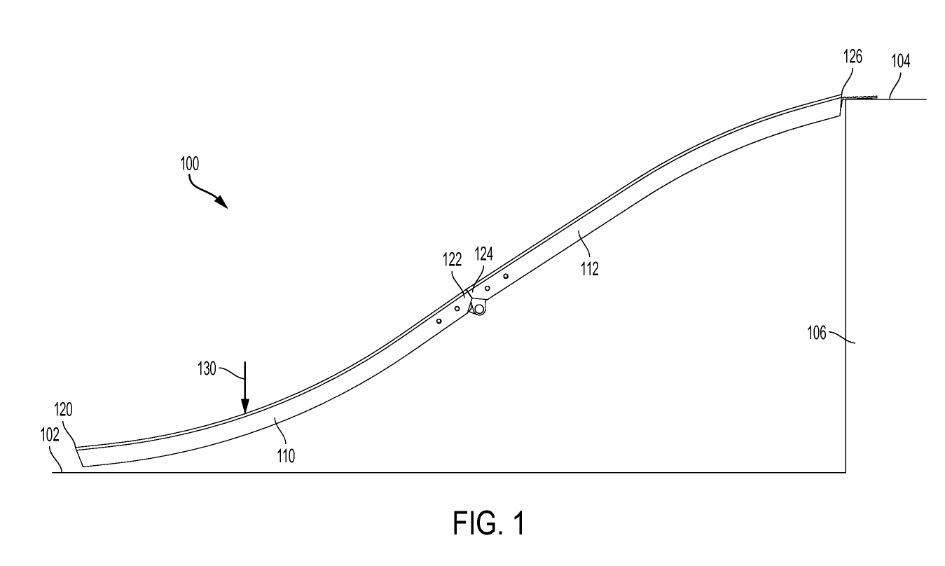

Turning to FIG. 1, a loading ramp 100 is illustrated. The loading ramp 100 can be supported between a first surface 102 and a second surface 104. In an example, the first surface 102 may include a floor, the ground, or any other surface upon which an object may rest.

The second surface 104 may, in some examples, be elevated with respect to the first surface 102. In the illustrated example, the second surface 104 is located at a height above the first surface 102. The second surface 104 can include, for example a vehicle 106 (e.g., car, truck, boat, plane, etc.) and/or a part of the vehicle 106. In this example, the second surface 104 includes a part of a tailgate of the vehicle 106, such that the tailgate supports the loading ramp 100. The second surface 104 is not limited to including the vehicle 106, and, in other examples, may include nearly any type of surface.

While the second surface 104 is illustrated as being elevated with respect to the first surface 102, the loading ramp 100 is not limited to being used in such a situation. Rather, in some examples, the first surface 102 may be elevated with respect to the second surface 104. Further, the first surface 102 and the second surface 104 can, in one example, be substantially parallel with respect to each other.

In any of the aforementioned examples, the loading ramp 100 can be supported at one end by the first surface 102 and at an opposing end by the second surface 104. In these examples, the loading ramp 100 can include a first ramp portion 110 and a second ramp portion 112. The first ramp portion 110 and the second ramp portion 112 can be attached with respect to each other. The first ramp portion 110 can be supported on the first surface 102. The second ramp portion 112, which is attached to the first ramp portion 110, can be supported on the second surface 104. In a possible example, a bottom end (e.g., a first end) of the first ramp portion 110 can be substantially planar with respect to the first surface 102. Similarly, in an example, a top end (e.g., a fourth end) of the second ramp portion 112 is substantially planar with respect to the second surface 104. As such, in some examples, the first ramp portion 110 can be positioned at a lower elevation than the second ramp portion 112. It will be appreciated that the bottom end is not limited to being planar with the first surface 102, and in other examples, may be non-planar with the first surface 102. In such an example, the bottom end of the first ramp portion 110 can extend at an angle with respect to the first surface 102. In further examples, either or both the top end or the bottom end of the loading ramp 100 can include feet (e.g., as illustrated at the top end) so as to ease the transition of the vehicle between the loading ramp 100 and the first surface 102 or the second surface 104.

The first ramp portion 110 can extend between a first end 120, which is supported on the first surface 102, and an opposing second end 122. The first ramp portion 110 includes any number of lengths between the first end 120 and the second end 122, such as, for example, between about 0.3 meters (˜1 foot) to about 1.5 meters (˜5 feet).

The second ramp portion 112 can extend between a third end 124 and an opposing fourth end 126. The second ramp portion 112 includes any number of lengths between the third end 124 and the fourth end 126, such as, for example, between about 0.3 meters (˜1 foot) to about 1.5 meters (˜5 feet).

In operation, the loading ramp 100 can support a weight 130. It will be appreciated that the weight 130 is generically/schematically illustrated because the weight 130 includes any number of structures, objects, etc. For example, the weight 130 may be provided as a result of a second vehicle, such as a motorcycle, all-terrain vehicle (ATV), snowmobile, etc. Further, these second vehicles may include zero or more tires/wheels, such that the weight 130 may be applied at a plurality (e.g., one or more) of locations along the loading ramp 100. In some examples, the loading ramp 100 comprises a plurality of loading ramps 100 (e.g., one or more), such that the plurality of loading ramps 100 can be supported between the first surface 102 and the second surface 104. In such an example, the loading ramps 100 can be positioned in a side by side configuration, so as to support vehicles that have a plurality of tires, such as all-terrain vehicles with four or six tires or the like. For ease of illustration, FIG. 1 illustrates a single loading ramp 100, though, in other examples, a plurality of loading ramps 100 may be provided.

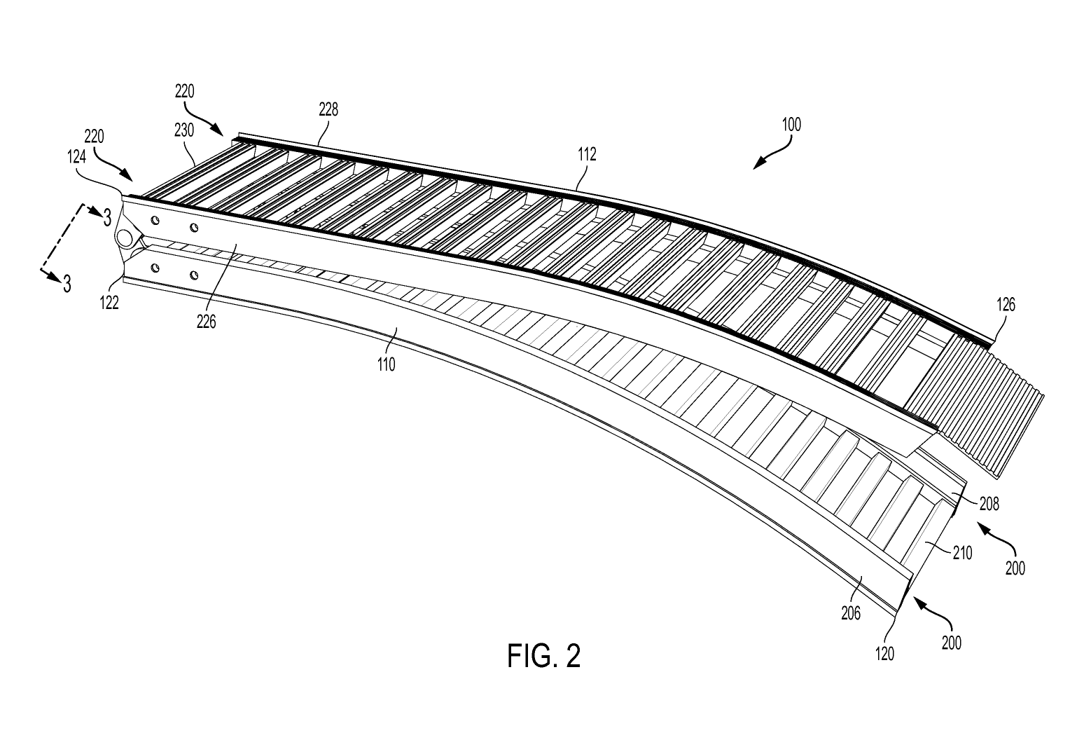

Turning to FIG. 2, the loading ramp 100 is illustrated in a partially nested (e.g., collapsed, non-extended, etc.) position. As will be described herein, the loading ramp 100 can be moved between an extended position (e.g., as illustrated in FIG. 1), and a non-extended, partially nested position (e.g., as illustrated in FIG. 2).

The first ramp portion 110 may include a first rail portion 200. The first rail portion 200 can extend along a first non-linear axis. The first non-linear axis can include a curve, bend, undulation, or the like such that the first rail portion 200 has a degree of curvature. In this example, the first non-linear axis has a generally concave shape, though other shapes are envisioned. The first rail portion 200 can extend between the first end 120 and the second end 122.

The first rail portion 200 can include a first rail 206 and a second rail 208. The first rail 206 and the second rail 208 are spaced apart and extend between the first end 120 and the second end 122. The first rail 206 and the second rail 208 can extend generally parallel to each other along the first non-linear axis. In this example, the first rail 206 and the second rail 208 have a generally identical size, shape, configuration, etc. While the first rail portion 200 includes two rails in this example, the first rail portion 200 is not so limited. Rather, in other examples, the first rail portion 200 may include one or more rails (e.g., the first rail 206 and/or the second rail 208 and/or additional rails). In an example, the first rail portion 200 can include the first rail 206 without the second rail 208, such that the first rail portion 200 includes one rail. The first rail portion 200 (e.g., the first rail 206 and/or the second rail 208) includes any number of materials, including metal materials (e.g., aluminum, steel, etc.), composite materials, polymeric materials (e.g., plastics, structural foams, etc.), or combinations thereof.

The first ramp portion 110 can include at least one first tread portion 210 that may be fixedly attached to the first rail portion 200. The at least one first tread portion 210 includes any number of tread portions (e.g., one or more). In this example, the first tread portions 210 can be generally identical in size, shape, and structure. The at least one first tread portion 210 can support the weight 130 (e.g., vehicle, atv, snowmobile, etc.) when the at least one first tread portion 210 is attached to the first rail portion 200. The first tread portion 210 can include any number of materials, including metal materials (e.g., steel, aluminum, etc.) or the like. In other examples, non-metal materials are envisioned, such as composite materials, polymeric materials (e.g., plastics, structural foams, etc.), etc.

Referring now to the second ramp portion 112, in some examples, the second ramp portion 112 can be positioned at a higher elevation than the first ramp portion 110. The second ramp portion 112 can include a second rail portion 220. The second rail portion 220 can extend along a second non-linear axis. The second non-linear axis can include a curve, bend, undulation, or the like such that the second rail portion 220 has a degree of curvature. In this example, the second non-linear axis has a generally convex shape, though other shapes are envisioned. In the illustrated example, the second non-linear axis may be a minor image duplication of the first non-linear axis, though, the first non-linear axis and the second non-linear axis are not so limited. Rather, in other examples, the first non-linear axis and the second non-linear axis may not be mirror images of each other. Accordingly, the first ramp portion 110 and the second ramp portion 112 have substantially opposite shapes, such that the loading ramp 100 has a generally S-shaped curve.

The second rail portion 220 can extend between a third end 124, which is attached to the second end 122 of the first rail portion 200, and an opposing fourth end 126. The fourth end 126 of the second rail portion 220 can be supported on the second surface 104. In an example, the length of the first rail portion 200 is substantially equal to the length of the second rail portion 220. In other examples, however, the lengths may not be substantially equal and could be different.

The second rail portion 220 can include a third rail 226 and a fourth rail 228. The third rail 226 and the fourth rail 228 are spaced apart and extend between the third end 124 and the fourth end 126. The third rail 226 and the fourth rail 228 can extend generally parallel to each other along the second non-linear axis. In this example, the third rail 226 and the fourth rail 228 have a generally identical size, shape, configuration, etc.

While the second rail portion 220 includes two rails in this example, the second rail portion 220 is not so limited. Rather, in other examples, the second rail portion 220 may include one or more rails (e.g., the third rail 226 and/or the fourth rail 228 and/or additional rails). In an example, the second rail portion 220 can include the third rail 226 without the fourth rail 228, such that the second rail portion 220 includes one rail. The second rail portion 220 (e.g., the third rail 226 and the fourth rail 228) includes any number of materials, including metal materials (e.g., aluminum, steel, etc.). In other examples, non-metal materials are envisioned, such as composite materials, polymeric materials (e.g., plastics, structural foams, etc.), etc.

The second ramp portion 112 can include at least one second tread portion 230 that may be fixedly attached to the second rail portion 220. The at least one second tread portion 230 includes any number of tread portions (e.g., one or more). In this example, the second tread portion 230 can be generally identical in size, shape, and structure. The at least one second tread portion 230 can support the weight 130 (e.g., vehicle, atv, snowmobile, etc.) when the at least one second tread portion 230 is attached to the second rail portion 220. The second tread portion 230 can include any number of materials, including metal materials (e.g., steel, aluminum, etc.) or the like. In other examples, non-metal materials are envisioned, such as composite materials, polymeric materials (e.g., plastics, structural foams, etc.), etc.

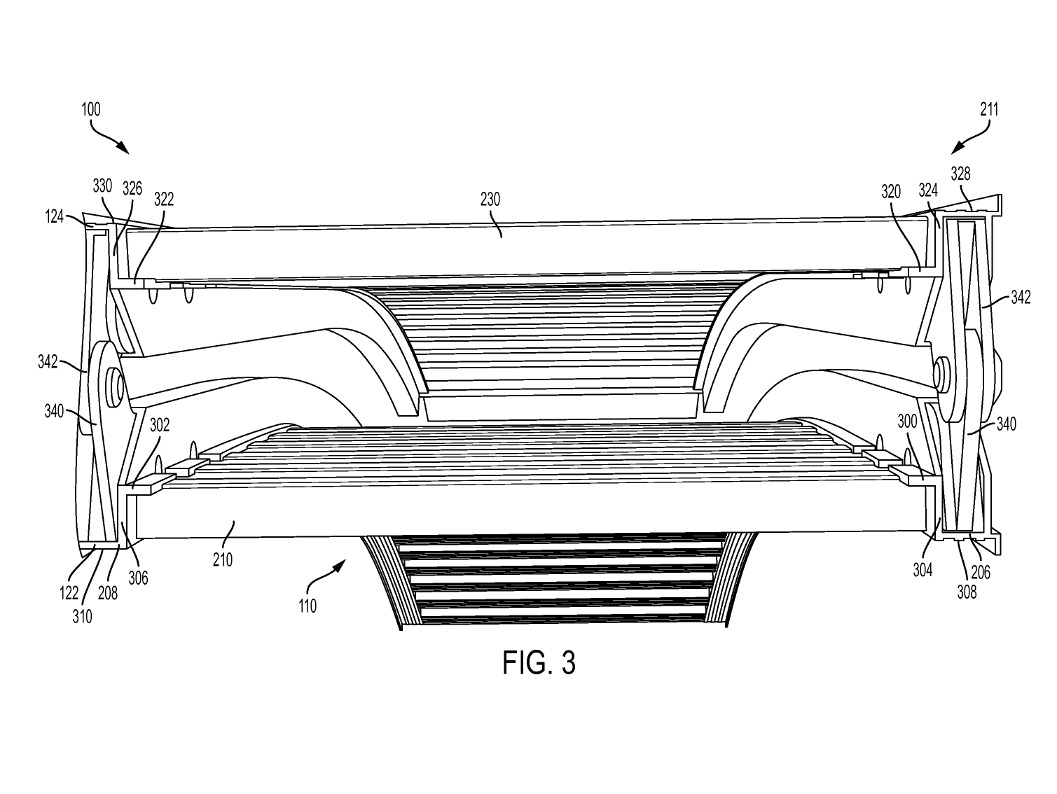

In this example, the first ramp portion 110, including the first rail portion 200 and the first tread portion 210, and the second ramp portion 112, including the second rail portion 220 and the second tread portion 230, can include an identical material. For example, the first rail portion 200, the first tread portion 210, the second rail portion 220, and the second tread portion 230 include a metal material. In a possible example, the metal material includes steel, aluminum, or the like. In other examples, non-metal materials are envisioned, such as composite materials, polymeric materials (e.g., plastics, structural foams, etc.), etc. Turning to FIG. 3, an end view of the loading ramp 100 is illustrated as viewed from the perspective indicated by lines 3-3 in FIG. 2. In this example, the first rail portion 200 can include a first ledge portion for supporting the first tread portion(s) 210. For example, the first ledge portion may include a first rail ledge 300 and a second rail ledge 302. The first rail ledge 300 can extend outwardly from the first rail 206 in a direction towards the second rail 208. The second rail ledge 302 can extend outwardly from the second rail 208 in a direction towards the first rail 206. The first rail ledge 300 and the second rail ledge 302 can form outcroppings, protuberances, projections, or the like. In some examples, the first rail ledge 300 and the second rail ledge 302 can extend partially or completely along the length of the first rail 206 and the second rail 208, respectively.

The first rail portion 200 may include a first support wall for supporting the first tread portion(s) 210. For example, the first support wall may include a first rail wall 304 and a second rail wall 306. The first rail wall 304 can extend substantially perpendicularly with respect to the first rail ledge 300. The second rail wall 306 can extend substantially perpendicularly with respect to the second rail ledge 302. As such, the first rail wall 304 and the second rail wall 306 can define a gap, a space, an opening, etc. therebetween. In a possible example, a distance separating the first rail wall 304 from the second rail wall 306 can substantially match a length of the first tread portion 210 between opposing ends of the first tread portion 210. In other examples, however, the distance need not match, and could be less than, greater than, etc. In an example, an upper surface 308 of the first rail wall 304, an upper surface 310 of the second rail wall 306, and an upper surface of the first tread portion 210 form a substantially planar surface.

Together, the first ledge portion (e.g., the first rail ledge 300 and the second rail ledge 302) and the first support wall (e.g., the first rail wall 304 and the second rail wall 306) can support the first tread portion(s) 210. In an example, the first tread portion 210 can be fixedly attached to the first ledge portion (e.g., the first rail ledge 300 and the second rail ledge 302) and the first support wall (e.g., the first rail wall 304 and the second rail wall 306). In a possible example, the first tread portion 210 can be attached to the first ledge portion (e.g., the first rail ledge 300 and the second rail ledge 302) and the first support wall (e.g., the first rail wall 304 and the second rail wall 306) with mechanical fasteners (e.g., screws, bolts, etc.) or adhesives. In another example, the first tread portion 210 can be attached to the first ledge portion (e.g., the first rail ledge 300 and the second rail ledge 302) and the first support wall (e.g., the first rail wall 304 and the second rail wall 306) via welding or an adhesive. In these examples, the first tread portion 210 is fixed and relatively non-movable with respect to the first ledge portion (e.g., the first rail ledge 300 and the second rail ledge 302) and the first support wall (e.g., the first rail wall 304 and the second rail wall 306).

Referring now to the second ramp portion 112, the second rail portion 220 can include a second ledge portion for supporting the second tread portion(s) 230. For example, the second ledge portion may include a third rail ledge 320 and a fourth rail ledge 322. The third rail ledge 320 can extend outwardly from the third rail 226 in a direction towards the fourth rail 228. The fourth rail ledge 322 can extend outwardly from the fourth rail 228 in a direction towards the third rail 226. The third rail ledge 320 and the fourth rail ledge 322 can form outcroppings, protuberances, projections, or the like. In some examples, the third rail ledge 320 and the fourth rail ledge 322 can extend partially or completely along the length of the third rail 226 and the fourth rail 228, respectively.

The second rail portion 220 may include a third support wall for supporting the second tread portion(s) 230. For example, the third support wall may include a third rail wall 324 and a fourth rail wall 326. The third rail wall 324 can extend substantially perpendicularly with respect to the third rail ledge 320. The fourth rail wall 326 can extend substantially perpendicularly with respect to the fourth rail ledge 322. As such, the third rail wall 324 and the fourth rail wall 326 can define a gap, a space, an opening, etc. therebetween. In a possible example, a distance separating the third rail wall 324 from the fourth rail wall 326 can substantially match a length of the second tread portion 230 between opposing ends of the second tread portion 230. In other examples, however, the distance need not match, and could be less than, greater than, etc. In an example, an upper surface 328 of the third rail wall 324, an upper surface 330 of the fourth rail wall 326, and an upper surface of the second tread portion 230 form a substantially planar surface.

Together, the second ledge portion (e.g., the third rail ledge 320 and the fourth rail ledge 322) and the second support wall (e.g., the third rail wall 324 and the fourth rail wall 326) can support the second tread portion(s) 230. In an example, the second tread portion 230 can be fixedly attached to the second ledge portion (e.g., the third rail ledge 320 and the fourth rail ledge 322) and the second support wall (e.g., the third rail wall 324 and the fourth rail wall 326). In a possible example, the second tread portion 230 can be attached to the second ledge portion (e.g., the third rail ledge 320 and the fourth rail ledge 322) and the second support wall (e.g., the third rail wall 324 and the fourth rail wall 326) with mechanical fasteners (e.g., screws, bolts, etc.) or adhesives. In another example, the second tread portion 230 can be attached to the second ledge portion (e.g., the third rail ledge 320 and the fourth rail ledge 322) and the second support wall (e.g., the third rail wall 324 and the fourth rail wall 326) via welding or an adhesive. In these examples, the second tread portion 230 is fixed and relatively non-movable with respect to the second ledge portion (e.g., the third rail ledge 320 and the fourth rail ledge 322) and the first support wall (e.g., the third rail wall 324 and the fourth rail wall 326).

In an example, the first ramp portion 110 includes a first hinge portion 340 at the second end 122 of the first ramp portion 110. The first hinge portion 340 can be attached to the first rail 206 and the second rail 208 of the first rail portion 200. In this example, the second ramp portion 112 includes a second hinge portion 342 at the third end 124 of the second ramp portion 112. The second hinge portion 342 can be attached to the third rail 226 and the fourth rail 228 of the second rail portion 220. The second hinge portion 342 of the second ramp portion 112 is movably attached with respect to the first hinge portion 340 of the first ramp portion 110. In this example, the first hinge portion 340 can be received within an opening defined within the second hinge portion 342. The first hinge portion 340 and the second hinge portion 342 can be attached and/or fixed together with a screw, a bolt, or other fastener. As such, the third end 124 of the second rail portion 220 is movable with respect to the second end 122 of the first rail portion 200.

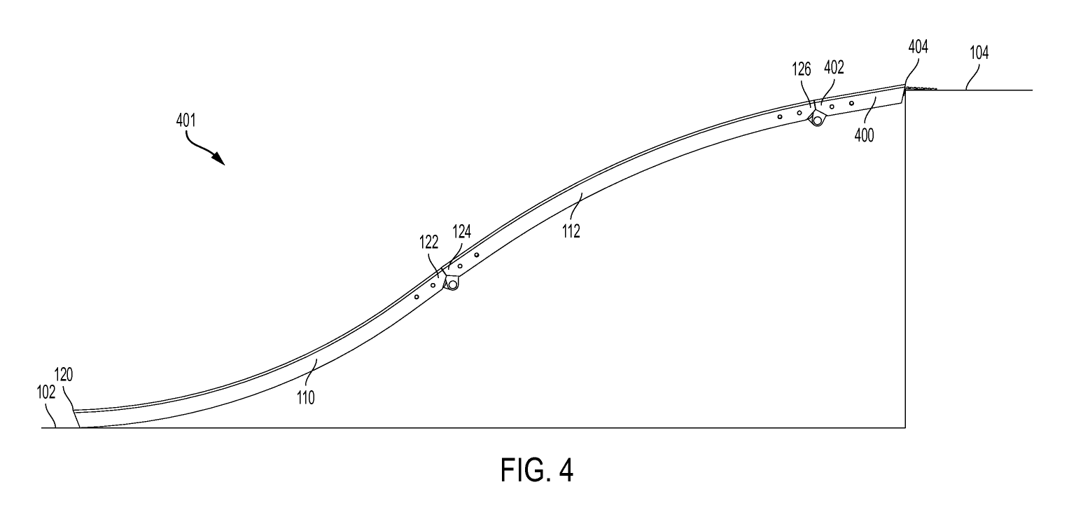

Turning to FIG. 4, a second example loading ramp 401 is illustrated. It will be appreciated that the dimensions of the loading ramp 401 and the degree of curvature that is illustrated in FIG. 4 is not intended to be limiting. Rather, in some examples, the curvature can be chosen to accommodate for low ground clearance vehicles. In this example, the first ramp portion 110 and the second ramp portion 112 can have different sizes and/or shapes than as illustrated and described with respect to FIG. 1. As such, the size/shape of the loading ramp 401 illustrated in FIG. 4 is merely intended as an example, and not as a limitation. The loading ramp 401 can include the first ramp portion 110 and the second ramp portion 112. In this example, the loading ramp 401 can include a third ramp portion 400 that is attached to the second ramp portion 112, with the third ramp portion 400 supported on the second surface 104. The third ramp portion 400 can extend between a fifth end 402 and a sixth end 404. In this example, the fifth end 402 can be attached to the fourth end 126 of the second ramp portion 112. The sixth end 404 can be supported on the second surface 104. In this example, the third ramp portion 400 has a length that is less than a length of the first ramp portion 110 or the second ramp portion 112.

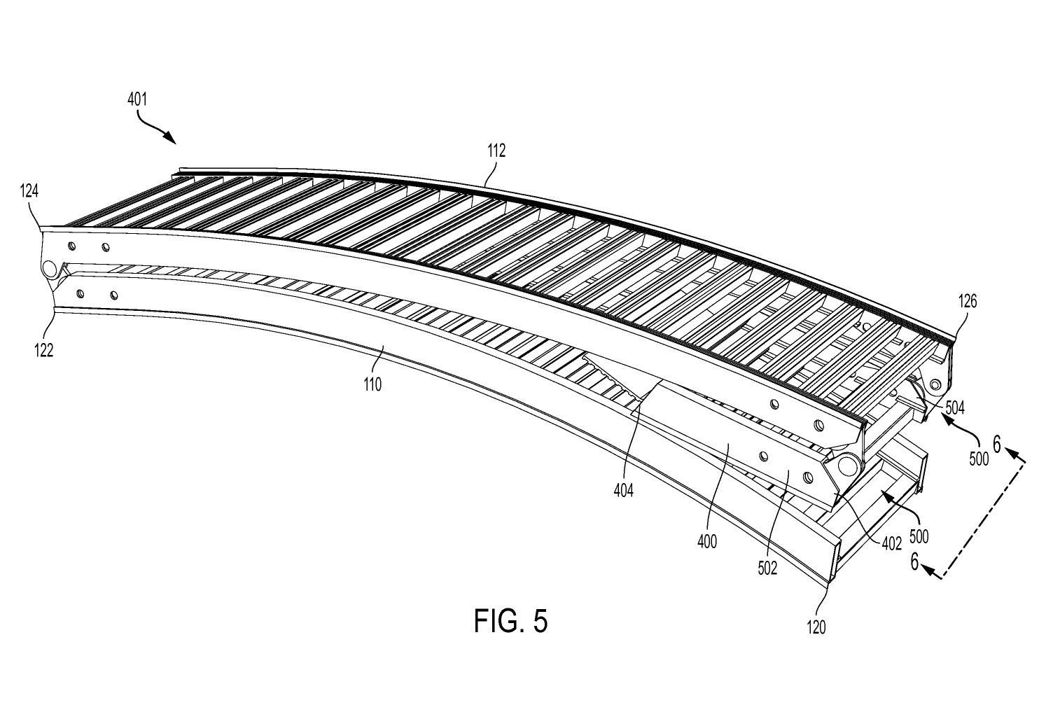

Turning to FIG. 5, the loading ramp 401 is illustrated in a partially nested (e.g., collapsed, non-extended, etc.) position. As will be described herein, the loading ramp 401 can be moved between an extended position (e.g., as illustrated in FIG. 4), and a non-extended, partially nested position (e.g., as illustrated in FIG. 5).

The third ramp portion 400 may include a third rail portion 500. The third rail portion 500 can extend along a third non-linear axis. The third non-linear axis can include a curve, bend, undulation, or the like such that the third rail portion 500 has a degree of curvature. In this example, the third non-linear axis has a generally concave shape, though other shapes are envisioned. The third rail portion 500 can extend between the fifth end 402 and the sixth end 404.

The third rail portion 500 can include a fifth rail 502 and a sixth rail 504. The fifth rail 502 and the sixth rail 504 are spaced apart and extend between the fifth end 402 and the sixth end 404. The fifth rail 502 and the sixth rail 504 can extend generally parallel to each other along the third non-linear axis. In this example, the fifth rail 502 and the sixth rail 504 have a generally identical size, shape, configuration, etc. While the third rail portion 500 includes two rails in this example, the third rail portion 500 is not so limited. Rather, in other examples, the third rail portion 500 may include one or more rails (e.g., the fifth rail 502 and/or the sixth rail 504 and/or additional rails). In an example, the third rail portion 500 can include the fifth rail 502 without the sixth rail 504, such that the third rail portion 500 includes one rail. The third rail portion 500 (e.g., the fifth rail 502 and/or the sixth rail 504) includes any number of materials, including metal materials (e.g., aluminum, steel, etc.), composite materials, polymeric materials (e.g., plastics, structural foams, etc.), or combinations thereof.

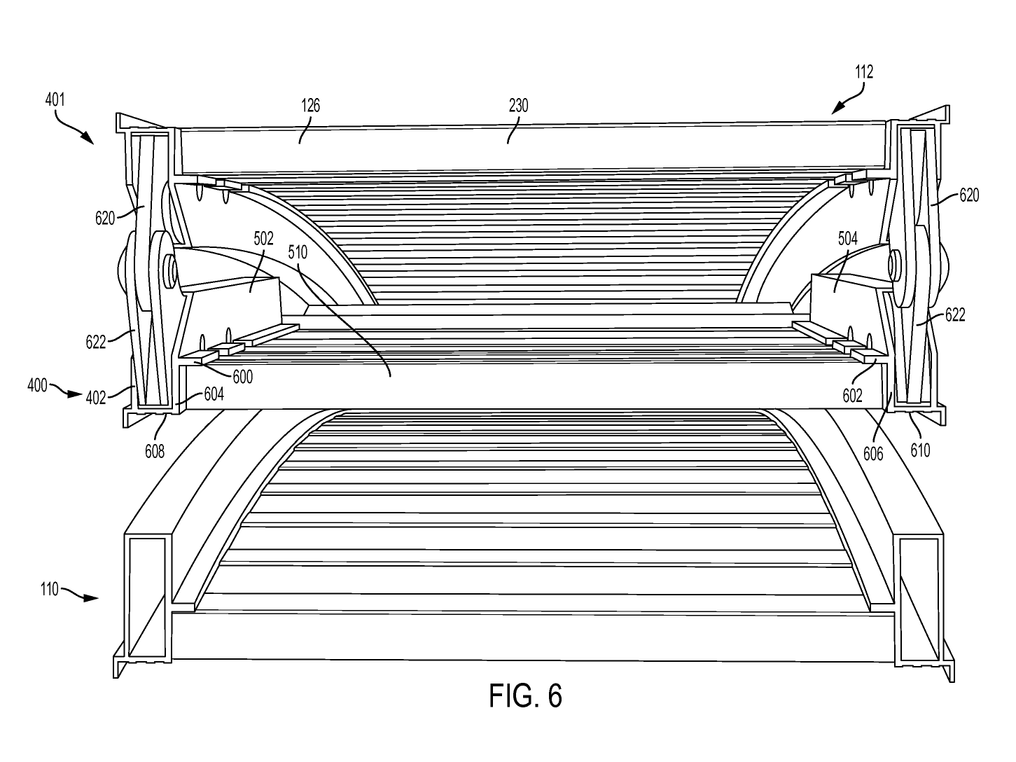

The third ramp portion 400 can include at least one third tread portion 510 (e.g., as illustrated in FIG. 6) that may be fixedly attached to the third rail portion 500. As used here, it will be appreciated that the term “tread” may also include rungs, continuous surfaces, or the like. The at least one third tread portion 510 includes any number of tread portions (e.g., one or more). In this example, the third tread portions 510 can be generally identical in size, shape, and structure. The at least one third tread portion 510 can support the weight 130 (e.g., vehicle, atv, snowmobile, etc.) when the at least one third tread portion 510 is attached to the third rail portion 500. The third tread portion 510 can include any number of materials, including metal materials (e.g., steel, aluminum, etc.) or the like. In other examples, non-metal materials are envisioned, such as composite materials, polymeric materials (e.g., plastics, structural foams, etc.), etc.

In this example, the first ramp portion 110, including the first rail portion 200 and the first tread portion 210, the second ramp portion 112, including the second rail portion 220 and the second tread portion 230, and the third ramp portion 400, including the third rail portion 500 and the third tread portion 510, can include an identical material. For example, the first rail portion 200, the first tread portion 210, the second rail portion 220, the second tread portion 230, the third rail portion 500, and the third tread portion 510 include a metal material. In a possible example, the metal material includes steel, aluminum, or the like. In other examples, non-metal materials are envisioned, such as composite materials, polymeric materials (e.g., plastics, structural foams, etc.), etc.

Turning to FIG. 6, an end view of the loading ramp 401 is illustrated as viewed from the perspective indicated by lines 6-6 in FIG. 5. In this example, the third rail portion 500 can include a third ledge portion for supporting the third tread portion(s) 510. For example, the third ledge portion may include a fifth rail ledge 600 and a sixth rail ledge 602. The fifth rail ledge 600 can extend outwardly from the fifth rail 502 in a direction towards the sixth rail 504. The sixth rail ledge 602 can extend outwardly from the sixth rail 504 in a direction towards the fifth rail 502. The fifth rail ledge 600 and the sixth rail ledge 602 can form outcroppings, protuberances, projections, or the like. In some examples, the fifth rail ledge 600 and the sixth rail ledge 602 can extend partially or completely along the length of the fifth rail 502 and the sixth rail 504, respectively.

The third rail portion 500 may include a third support wall for supporting the third tread portion(s) 510. For example, the third support wall may include a fifth rail wall 604 and a sixth rail wall 606. The fifth rail wall 604 can extend substantially perpendicularly with respect to the fifth rail ledge 600. The sixth rail wall 606 can extend substantially perpendicularly with respect to the sixth rail ledge 602. As such, the fifth rail wall 604 and the sixth rail wall 606 can define a gap, a space, an opening, etc. therebetween. In a possible example, a distance separating the fifth rail wall 604 from the sixth rail wall 606 can substantially match a length of the third tread portion 510 between opposing ends of the third tread portion 510. In other examples, however, the distance need not match, and could be less than, greater than, etc. In an example, an upper surface 608 of the fifth rail wall 604, an upper surface 610 of the sixth rail wall 606, and an upper surface of the third tread portion 510 form a substantially planar surface.

Together, the third ledge portion (e.g., the fifth rail ledge 600 and the sixth rail ledge 602) and the third support wall (e.g., the fifth rail wall 604 and the sixth rail wall 606) can support the third tread portion(s) 510. In an example, the third tread portion 510 can be fixedly attached to the third ledge portion (e.g., the fifth rail ledge 600 and the sixth rail ledge 602) and the third support wall (e.g., the fifth rail wall 604 and the sixth rail wall 606). In a possible example, the third tread portion 510 can be attached to the third ledge portion (e.g., the fifth rail ledge 600 and the sixth rail ledge 602) and the third support wall (e.g., the fifth rail wall 604 and the sixth rail wall 606) with mechanical fasteners (e.g., screws, bolts, etc.) or adhesives. In another example, the third tread portion 510 can be attached to the third ledge portion (e.g., the fifth rail ledge 600 and the sixth rail ledge 602) and the third support wall (e.g., the fifth rail wall 604 and the sixth rail wall 606) via welding or an adhesive. In these examples, the third tread portion 510 is fixed and relatively non-movable with respect to the third ledge portion (e.g., the fifth rail ledge 600 and the sixth rail ledge 602) and the third support wall (e.g., the fifth rail wall 604 and the sixth rail wall 606).

In an example, the second ramp portion 112 includes a third hinge portion 620 at the fourth end 126 of the second ramp portion 112. In this example, the second ramp portion 112 includes the second hinge portion 342 at the third end 124 and the third hinge portion 620 at the fourth end 126. The third hinge portion 620 can be attached to the third rail 226 and the fourth rail 228 of the second ramp portion 112. In this example, the third ramp portion 400 includes a fourth hinge portion 622 at the fifth end 502 of the third ramp portion 400. The fourth hinge portion 622 can be attached to the fifth rail 502 and the sixth rail 504 of the third rail portion 500. The fourth hinge portion 622 can be movably attached with respect to the third hinge portion 620 of the second ramp portion 112. In this example, the third hinge portion 620 can be received within an opening defined within the fourth hinge portion 622. The third hinge portion 620 and the fourth hinge portion 622 can be attached and/or fixed together with a screw, a bolt, or other fasteners. As such, the fifth end 502 of the third rail portion 500 is movable with respect to the fourth end 126 of the second rail portion 220.

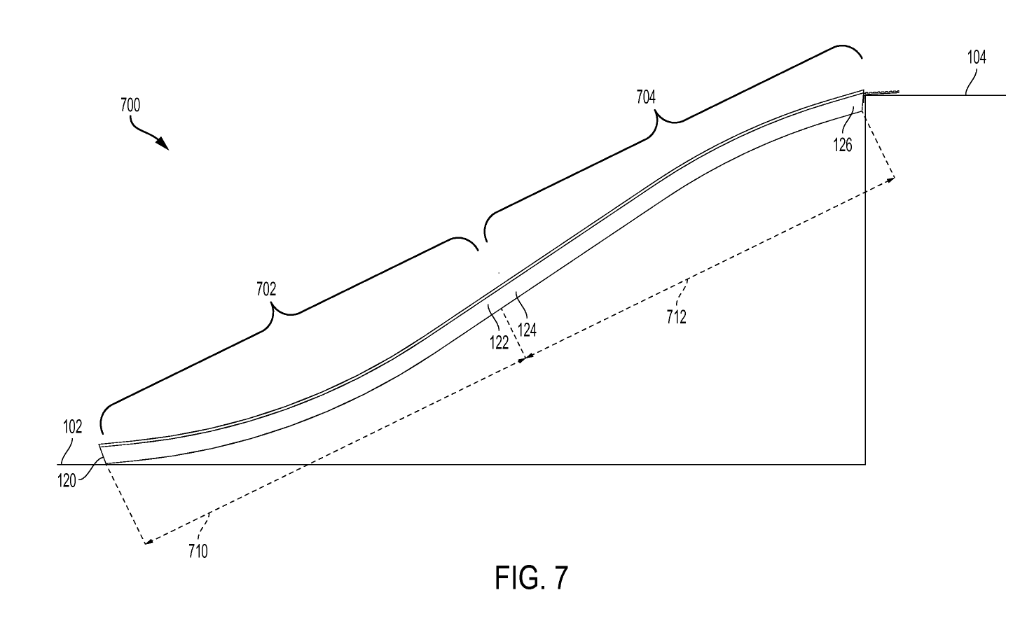

Turning to FIG. 7, a third example loading ramp 700 is illustrated. The loading ramp 700 can include a first ramp portion 702 and a second ramp portion 704. The first ramp portion 702 extends between the first end 120 and the second end 122. The second ramp portion 704 extends between the third end 124 and the fourth end 126. The first ramp portion 702 is similar in some respects to the first ramp portion 110. For example, the first ramp portion 702 includes the first rail portion 200 (e.g., the first rail 206 and the second rail 208) and the first tread portion 210. The second ramp portion 704 is similar in some respects to the second ramp portion 112. For example, the second ramp portion 704 includes the second rail portion 220 (e.g., the third rail 226 and the fourth rail 228) and the second tread portion 230.

The first ramp portion 702 can be defined as the portion of the loading ramp 700 that is concave facing in an upward direction (e.g., facing a first direction). The second ramp portion 704 can be defined as the portion of the loading ramp 700 that is concave facing a downward direction (e.g., facing a second direction that is opposite the first direction). As such, the first ramp portion 702 and the second ramp portion 704 can have shapes that are substantially mirror images of each other facing opposing directions though, in other examples, the first ramp portion 702 and the second ramp portion 704 may not be mirror images of each other.

In this example, the second ramp portion 704 is non-movably attached with respect to the first ramp portion 702. As such, the third end 124 of the of the second rail portion 220 of the second ramp portion 704 is non-movable with respect to the second end 122 of the first rail portion 200 of the first ramp portion 702. In this example, the first rail portion 200 and the second rail portion 220 can form a unitary, single-piece rail portion. In some examples, the first rail portion 200 and the second rail portion 220 are attached together, such as by welding, adhesives, mechanical fasteners, or the like. In other examples, such as the example illustrated in FIG. 7, the first rail portion 200 and the second rail portion 220 are a one-piece formed structure. In this example, the loading ramp 700, including the first ramp portion 702 and the second ramp portion 704, includes a metal material, such as aluminum, for example. In other examples, non-metal materials are envisioned, such as composite materials, polymeric materials (e.g., plastics, structural foams, etc.), etc.

The first ramp portion 702 can extend a first distance 710 while the second ramp portion 704 extends a second distance 712. In the illustrated example, the first distance is substantially equal to the second distance, such that the first ramp portion 702 and the second ramp portion 704 have a substantially equal length. In other examples, however, the first ramp portion 702 and the second ramp portion 704 can have differing lengths. For example, the second ramp portion 704 can extend the second distance 712 that is greater than the first distance 710 of the first ramp portion 702. In such an example, the second ramp portion 704 can have a longer length than the first ramp portion 702. In yet another example, the first ramp portion 702 can extend the first distance 710 that is greater than the second distance 712.

In this example, the first ramp portion 702 and the second ramp portion 704 can include an identical material. For example, the first ramp portion 702, including first rail portions, first tread portions, etc., and the second ramp portion 704, including second rail portions, second tread portions, etc., include a metal material. In a possible example, the metal material includes steel, aluminum, or the like. In other examples, non-metal materials are envisioned, such as composite materials, polymeric materials (e.g., plastics, structural foams, etc.), etc.

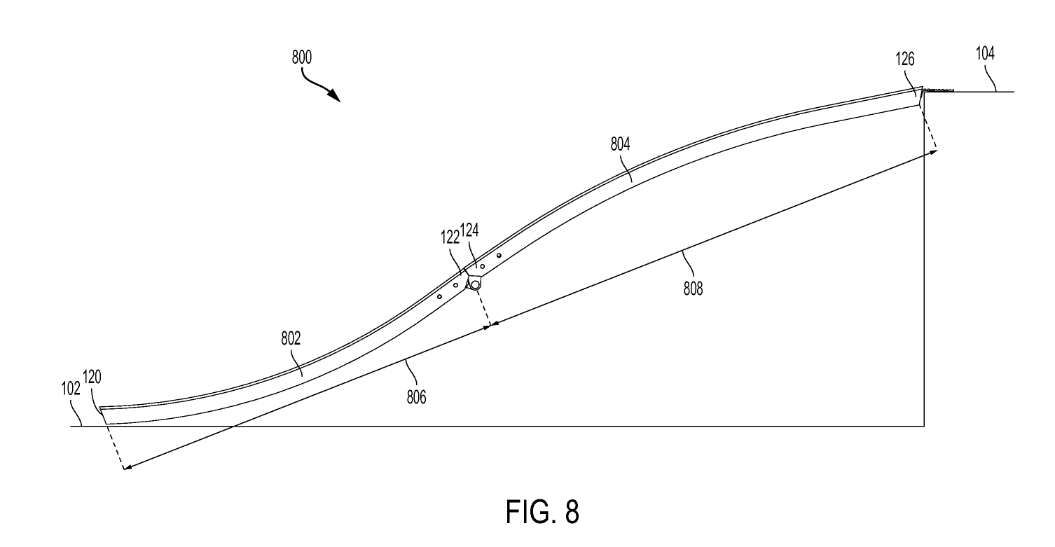

Turning to FIG. 8, a fourth example loading ramp 800 is illustrated. The loading ramp 800 can include a first ramp portion 802 and a second ramp portion 804. In this example, the first ramp portion 802 is similar to the first ramp portion 110, and may include the first rail portion 200 (e.g., the first rail 206, the second rail 208, etc.), the first tread portions 210, etc. The first ramp portion 802 can extend a first distance 806. The second ramp portion 804 is similar to the second ramp portion 112, and may include the second rail portion 220 (e.g., the third rail 226, the fourth rail 228, etc.), the second tread portions 230, etc. The second ramp portion 804 can extend a second distance 808. The first ramp portion 802 and the second ramp portion 804 can be movably attached to each other with the first hinge portion 340 and the second hinge portion 342.

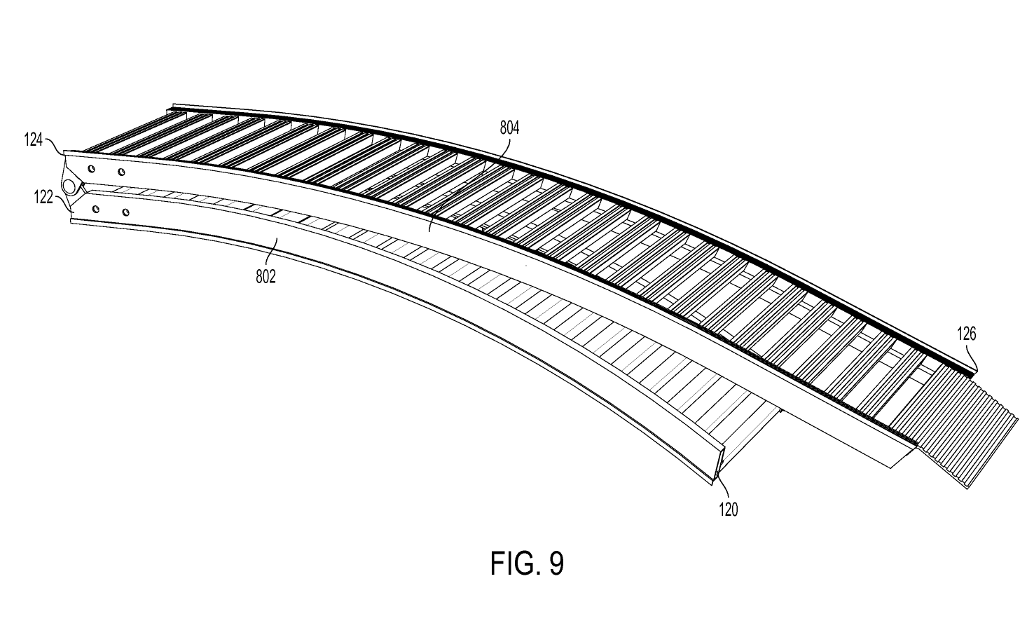

Referring to FIGS. 8 and 9, the first ramp portion 802 and the second ramp portion 804 can have differing lengths. In this example, the first distance 806 of the first ramp portion 802 is not equal to the second distance 808 of the second ramp portion 804. In the illustrated example, the second ramp portion 804 can extend the second distance 808 that is greater than the first distance 806 of the first ramp portion 802. The first ramp portion 802 and the second ramp portion 804 can extend along the non-linear axis, such that the first ramp portion 802 and the second ramp portion 804 can be nested in a folded position (FIG. 9). That is, in the folded position, the first ramp portion 802 and the second ramp portion 804 are nested such that a minimal space exists between the first ramp portion 802 and the second ramp portion 804. Due to the shapes (e.g., extending along the non-linear axis) of the first ramp portion 802 and the second ramp portion 804, the first ramp portion 802 and the second ramp portion 804 have substantially matching shapes (e.g., but for the difference in lengths) and extend along substantially parallel axes.

In this example, the first ramp portion 802, including a first rail portion and a first tread portion, and the second ramp portion 804, including a second rail portion and a second tread portion, can include an identical material. For example, the first ramp portion 802 and the second ramp portion 804 can include a metal material. In a possible example, the metal material includes steel, aluminum, or the like. In other examples, non-metal materials are envisioned, such as composite materials, polymeric materials (e.g., plastics, structural foams, etc.), etc.

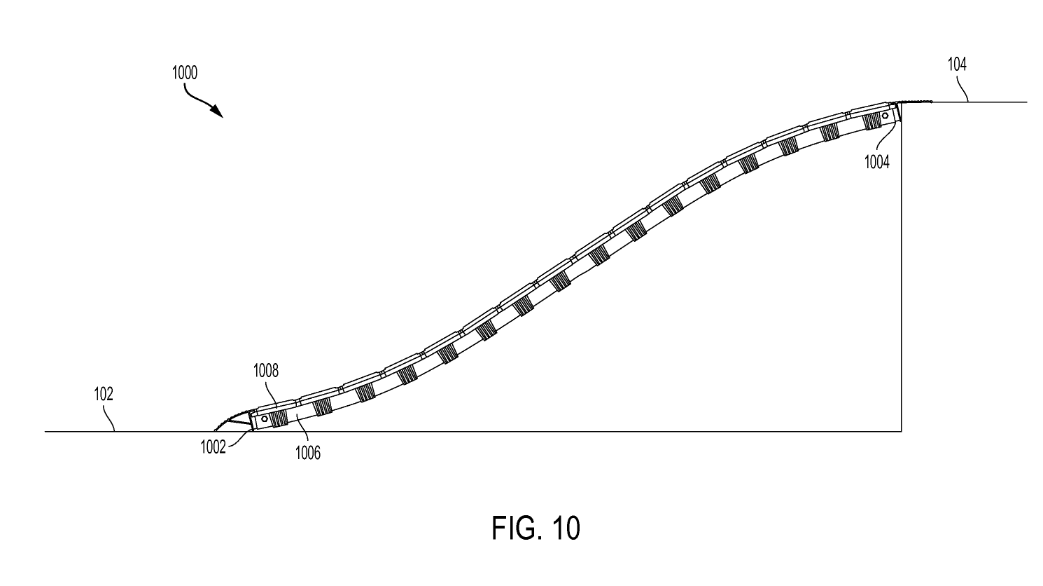

Turning to FIG. 10, a fifth example loading ramp 1000 is illustrated. The loading ramp 1000 can extend between a first end 1002 and an opposing second end 1004. The first end 1002 can be supported on the first surface 102 while the second end 1004 can be supported on the second surface 104. In this example, the loading ramp 1000 can include a rail portion 1006. In some examples, the rail portion 1006 includes a first rail and a second rail. The rail portion 1006 can extend along a non-linear axis.

The loading ramp 1000 can include at least one tread portion 1008. The tread portions 1008 can be removably attached to the rail portion 1006. In this example, the rail portion 1006 includes any number of materials, including metal materials (e.g., aluminum, steel, etc.), composite materials, polymeric materials (e.g., plastics, structural foams, etc.), or combinations thereof. The tread portions 1008 can include a structural foam material, a plastic material (e.g., an injection molded plastic, etc.), polymer materials, metal materials (e.g., steel, aluminum, etc.) or the like.

The rail portion 1006 can extend substantially continuously between the first end 1002 and the second end 1004. That is, in this example, the rail portion 1006 includes a unitary, single-piece rail portion extending between the first end 1002 and the second end 1004. The rail portion 1006 therefore does not provide for bending, flexing, nesting, or the like. Rather, the rail portion 1006 is a substantially non-flexible, static structure that extends between the first end 1002 and the second end 1004.

It will be appreciated that the term “attached” as used herein may encompass ramps that have a plurality of portions that are separately attached, such as via a hinge (e.g., as illustrated in FIGS. 1 to 6, 8 and 9), and ramps that are single, one piece unitary structures (e.g., as illustrated in FIGS. 7 and 10). With respect to the latter, the single, one piece unitary structure can comprise a first portion, a second portion, etc. that are functionally attached, such as by welding, being formed as a single piece, etc.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing at least some of the claims.

Various operations of embodiments are provided herein. The order in which some or all of the operations described should not be construed to imply that these operations are necessarily order dependent. Alternative ordering will be appreciated having the benefit of this description. Further, it will be understood that not all operations are necessarily present in each embodiment provided herein. Also, it will be understood that not all operations are necessary in some embodiments.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first rail and a second rail generally correspond to rail A and rail B or two different or two identical rails or the same rail.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally to be construed to mean “one or more” unless specified otherwise or clear from context to be directed to a singular form. Also, at least one of A and B or the like generally means A or B or both A and B. Furthermore, to the extent that “includes”, “having”, “has”, “with”, or variants thereof are used in either the detailed description or the claims, such terms are intended to be inclusive in a manner similar to “comprising”.

Also, although the disclosure has been illustrated and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A loading ramp configured to be supported between a first surface and a second surface, the loading ramp including:
a first ramp portion configured to be supported on the first surface, the first ramp portion including:
a first rail portion extending between a first end, which is supported on the first surface, and an opposing second end, the first rail portion extending along a first non-linear axis; and
at least one first tread portion fixedly attached to the first rail portion, the at least one first tread portion configured to support a weight when the at least one first tread portion is attached to the first rail portion;
a second ramp portion attached to the first ramp portion and configured to be supported on the second surface, the second ramp portion including:
a second rail portion extending between a third end, which is attached to the second end of the first rail portion, and an opposing fourth end, which is supported on the second surface, the second rail portion extending along a second non-linear axis; and
at least one second tread portion fixedly attached to the second rail portion, the at least one second tread portion configured to support the weight when the at least one second tread portion is attached to the second rail portion.

2. The loading ramp of claim 1, wherein the first rail portion, the at least one first tread portion, the second rail portion, and the at least one second tread portion include a metal material.

3. The loading ramp of claim 2, wherein the metal material includes at least one of steel or aluminum.

4. The loading ramp of claim 1, wherein the second ramp portion is non-movably attached with respect to the first ramp portion such that the third end of the second rail portion is non-movable with respect to the second end of the first rail portion.

5. The loading ramp of claim 4, wherein the first rail portion and the second rail portion include a unitary, single-piece rail portion.

6. The loading ramp of claim 5, wherein the second ramp portion is movably attached with respect to the first ramp portion such that the third end of the second rail portion is movable with respect to the second end of the first rail portion.

7. The loading ramp of claim 6, wherein:
the first ramp portion includes a first hinge portion at the second end; and
the second ramp portion includes a second hinge portion at the third end, and a third hinge portion at the fourth end.

8. The loading ramp of claim 7, wherein the second hinge portion of the second ramp portion is movably attached with respect to the first hinge portion of the first ramp portion.

9. The loading ramp of claim 8, wherein the loading ramp includes:
a third ramp portion attached to the fourth end of the second ramp portion, the third ramp portion including:
a third rail portion extending between a fifth end, which is attached to the fourth end of the second rail portion, and an opposing sixth end; and
at least one third tread portion attached to the third rail portion, the at least one third tread portion configured to support the weight when the at least one third tread portion is attached to the third rail portion.

10. The loading ramp of claim 9, wherein the third ramp portion includes a fourth hinge portion at the fifth end, the fourth hinge portion movably attached with respect to the third hinge portion of the second ramp portion.

11. A loading ramp configured to be supported between a first surface and a second surface, the loading ramp including:
a first ramp portion configured to be supported on the first surface, the first ramp portion including:
a first rail portion extending between a first end, which is supported on the first surface, and an opposing second end, the first rail portion extending along a first non-linear axis; and
at least one first tread portion attached to the first rail portion, the at least one first tread portion configured to support a weight when the at least one first tread portion is attached to the first rail portion;
a second ramp portion attached to the first ramp portion, the second ramp portion including:
a second rail portion extending between a third end, which is attached to the second end of the first rail portion, and an opposing fourth end, the second rail portion extending along a second non-linear axis;
at least one second tread portion attached to the second rail portion, the at least one second tread portion configured to support the weight when the at least one second tread portion is attached to the second rail portion; and
a third ramp portion attached to the second ramp portion and configured to be supported on the second surface, the third ramp portion including:
a third rail portion extending between a fifth end, which is attached to the fourth end of the second rail portion, and an opposing sixth end, which is supported on the second surface; and
at least one third tread portion attached to the third rail portion, the at least one third tread portion configured to support the weight when the at least one third tread portion is attached to the third rail portion.

12. The loading ramp of claim 11, wherein the third ramp portion is movably attached with respect to the second ramp portion such that the fifth end of the third rail portion is movable with respect to the fourth end of the second rail portion.

13. The loading ramp of claim 12, wherein the second ramp portion is movably attached with respect to the first ramp portion such that the third end of the second rail portion is movable with respect to the second end of the first rail portion.

14. The loading ramp of claim 11, wherein the first rail portion, the at least one first tread portion, the second rail portion, the at least one second tread portion, the third rail portion, and the at least one third tread portion include a metal material.

15. The loading ramp of claim 14, wherein the metal material includes at least one of steel or aluminum.

16. A loading ramp configured to be supported between a first surface and a second surface, the loading ramp including:
a first ramp portion configured to be supported on the first surface, the first ramp portion extending a first distance, the first ramp portion including:
a first rail portion extending between a first end, which is supported on the first surface, and an opposing second end, the first rail portion extending along a first non-linear axis; and
at least one first tread portion fixedly attached to the first rail portion, the at least one first tread portion configured to support a weight when the at least one first tread portion is attached to the first rail portion;
a second ramp portion attached to the first ramp portion and configured to be supported on the second surface, the second ramp portion extending a second distance that is greater than the first distance, the second ramp portion including:
a second rail portion extending between a third end, which is attached to the second end of the first rail portion, and an opposing fourth end, which is supported on the second surface, the second rail portion extending along a second non-linear axis; and
at least one second tread portion fixedly attached to the second rail portion, the at least one second tread portion configured to support the weight when the at least one second tread portion is attached to the second rail portion.

17. The loading ramp of claim 16, wherein the first rail portion, the at least one first tread portion, the second rail portion, and the at least one second tread portion include a metal material.

18. The loading ramp of claim 17, wherein the metal material includes aluminum.

19. The loading ramp of claim 16, wherein the second ramp portion is non-movably attached with respect to the first ramp portion such that the third end of the second rail portion is non-movable with respect to the second end of the first rail portion.

20. The loading ramp of claim 16, wherein at least one of the first rail portion, the at least one first tread portion, the second rail portion, or the at least one second tread portion include a non-metal material.
